(19) United States
(12) Patent Application Publication
(10) Pub. No.: US 2026/0172518 A1
(43) Pub. Date: Jun. 18, 2026

(54) IMAGE READING DEVICE AND IMAGE FORMING APPARATUS

(71) Applicant: Keita Inoue, Kanagawa (JP)

(72) Inventor: Keita Inoue, Kanagawa (JP)

(73) Assignee: ETRIA CO., LTD., Yokohama (JP)

(21) Appl. No.: 19/352,081

(22) Filed: Oct. 7, 2025

(30) Foreign Application Priority Data
Dec. 18, 2024 (JP) 2024-223623

(51) Int. Cl. H04N 1/053; H04N 1/00

(52) U.S. Cl. CPC H04N 1/053; H04N 1/00018; H04N 1/00037; H04N 1/00824

(57) ABSTRACT

An image reading device includes a carriage; a position sensor; a motor; and circuitry. The carriage performs a first reciprocal scanning operation starting from a first position. The position sensor switches a ON/OFF state in accordance with a detection of the carriage at the second position. The circuitry determines whether the carriage has an abnormality based on the number of pulses of the clock signal and the ON/OFF state; and causes the motor to, when the circuitry determines that the carriage has the abnormality, move the carriage back to the first position in the return direction and move the carriage in the forward direction to perform a second reciprocal scanning operation. The circuitry further moves the carriage a first moving distance in the first reciprocal scanning operation; and moves the carriage a second moving distance, equal to or greater than the first moving distance, in the second reciprocal scanning operation.

### CROSS-REFERENCE TO RELATED APPLICATIONS

This patent application is based on and claims priority pursuant to 35 U.S.C. § 119(a) to Japanese Patent Application No. 2024-223623, filed on Dec. 18, 2024, in the Japan Patent Office, the entire disclosure of which is hereby incorporated by reference herein.

### BACKGROUND

### Technical Field

The present disclosure relates to an image reading device and an image forming apparatus.

### Related Art

A technique has been developed for an image reading device (scanner) including a position sensor that detects a reference position of a carriage that performs scanning to read a document. The technique involves counting the number of pulses of the carriage that performs scanning, and checking whether the position sensor is on or off at a position to which the carriage moves by a distance corresponding to a certain number of pulses to detect the presence or absence of an abnormality in the driving of the carriage.

### SUMMARY

The present disclosure described herein provides an image reading device includes an image sensor to read an image on an object; and a light source to emit light to the object; a carriage; a position sensor; a motor; and circuitry. The carriage is movable in a forward direction and a return direction opposite to the forward direction; and performs a first reciprocal scanning operation starting from a first position. The carriage mounts at least one of the image sensor or the light source. The position sensor detects the carriage, in the forward direction, at the first position; and a second position different from the first position; and switches a ON/OFF state between ON and OFF in accordance with a detection of the carriage at the second position. The motor moves the carriage to perform a first reciprocal scanning operation. The circuitry generates a clock signal to generate a drive signal; outputs, to the motor, the drive signal in accordance with the clock signal to drive the motor to move the carriage; counts a number of pulses of the clock signal; determines whether the carriage has an abnormality based on the number of pulses of the clock signal and the ON/OFF state of the position sensor; and causes the motor to, when the circuitry determines that the carriage has the abnormality: move the carriage back to the first position in the return direction; move the carriage in the forward direction to change the ON/OFF state of the position sensor to perform a second reciprocal scanning operation. The circuitry further moves the carriage a first moving distance in the first reciprocal scanning operation; and moves the carriage a second moving distance, equal to or greater than the first moving distance, in the second reciprocal scanning operation.

The present disclosure described herein provides an image forming apparatus including the image reading device; and an image former to form an image read by the image reading device on a medium.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a view of an image reading device, which is a scanner, according to an embodiment of the present disclosure;

FIG. 2 is a block diagram illustrating an example of functions of the image reading device according to the embodiment of the present disclosure;

FIG. 3 is a diagram illustrating carriage operations of the image reading device, or the scanner, according to the embodiment of the present disclosure;

FIG. 4 is a diagram illustrating a method for determining an error in the operation of a carriage in the image reading device according to the embodiment of the present disclosure;

FIG. 5 is a flowchart illustrating an error determination process according to a comparative example, for the carriage during a document reading operation illustrated in FIG. 4;

FIG. 6A is a flowchart illustrating an example of an error determination process for the carriage during the document reading operation according to the embodiment of the present disclosure;

FIG. 6B is a flowchart illustrating an example of a retry process during the document reading operation according to the embodiment of the present disclosure;

FIG. 7A is a flowchart illustrating an example of an error determination process for the carriage during a reference white plate reading operation according to the embodiment of the present disclosure;

FIG. 7B is a flowchart illustrating an example of a retry process during the reference white plate reading operation according to the embodiment of the present disclosure;

FIG. 8 is a diagram illustrating an example of the display of an error log screen according to the embodiment of the present disclosure;

FIG. 9 is a diagram illustrating examples of an operation panel screen according to the embodiment of the present disclosure;

FIG. 10 is a diagram illustrating an example of an effect of the embodiment of the present disclosure; and

FIG. 11 is a diagram illustrating an example of an image forming apparatus including the image reading device according to the embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A typical abnormality detection method for the driving of the carriage can notify a user of an abnormality immediately after the abnormality has occurred during the driving of the carriage. For example, if an error occurs during the reading of a reference white plate, the abnormality detection method provides a notification of even an abnormality in the carriage that is sudden but can be recovered, such as a step-out error, and forcibly stops the image reading device for recovery. To recover the image reading device, the power of the image reading device is turned from off to on to restart the image reading device. Thus, the user's downtime, which is a period of time during which the user is unable to use the image reading device, is prolonged.

Accordingly, in an image reading device and an image forming apparatus, it is desirable to reduce the downtime during which a user is unable to use the image reading device.

According to one aspect of the present disclosure, the downtime during which a user is unable to use an image reading device can be reduced.

An image reading device and an image forming apparatus according to an embodiment of the present disclosure will be described in detail hereinafter with reference to the accompanying drawings.

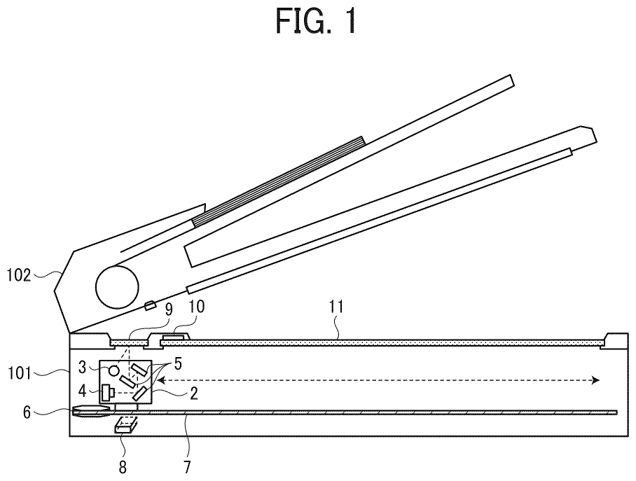

FIG. 1 is a view of an image reading device 101, which is a scanner, according to the present embodiment. The image reading device 101 is a scanner device mounted on an image forming apparatus such as a digital copier, a digital multifunction peripheral, or a facsimile machine, or is a stand-alone scanner device. In other words, the image reading device 101 may have at least one or more functions of copy printing, scanner transmission, and facsimile (fax) transmission. The image reading device 101 illuminates a document, which is a subject, with light emitted from a light source 3, receives light reflected from the document using an image sensor board 4, processes a signal output from the image sensor board 4, and reads image data of the document. In other words, the image sensor board 4 is an example of an image sensor that reads an image of an object such as a document. The light source 3 is an example of a light source that irradiates the object with light.

The image reading device 101 includes at least one of: a copier printer; a scanner transmitter; or a facsimile transmitter.

As illustrated in FIG. 1, a carriage 2 includes the light source 3 to expose the document to light, the image sensor board 4 to receive reflected light from the light source 3 and convert the reflected light into a signal, and reflection mirrors 5 for transmitting the reflected light from the light source 3 to the image sensor board 4. Components mounted on the image sensor board 4 include a lens for forming an image, and an analog front end (AFE) for converting an analog signal of light received by the image sensor board 4 into a digital signal.

The carriage 2 may have a configuration referred to as a reduction optical system including a charge coupled device (CCD) sensor or a configuration referred to as a contact optical system including a contact image sensor (CIS), although the configuration of the carriage 2 is not limited thereto. The image reading device 101 illustrated in FIG. 1 is of an integrated type in which components such as the light source 3, the image sensor board 4, and the reflection mirrors 5 are assembled in the carriage 2. In another example, the image reading device 101 may be of a type in which the light source 3 and the reflection mirrors 5 are used as the carriage 2 to perform scanning while the image sensor board 4 is fixed. In other words, the carriage 2 includes at least one of the image sensor board 4 and the light source 3.

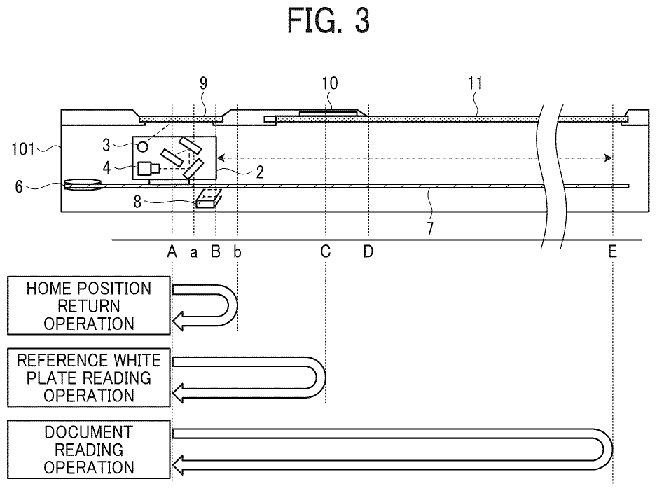

In the image reading device 101, a document is placed on a contact glass 11, and the carriage 2 performs reciprocal scanning along a sub-scanning direction (an example of a one-dimensional direction). The image reading device 101 has a mechanism in which, during flatbed scanning for reading an image, a position sensor 8 identifies the position of the carriage 2 and a drive motor 6 rotates to drive the carriage 2, which is coupled to a drive belt 7, to perform scanning to read a reference white plate 10 and the document placed on the contact glass 11, after which the carriage 2 returns to the initial position. The reference white plate 10 is used to, for example, correct various kinds of variations caused by the reading optical system. The position sensor 8 is an example of a position sensor that detects an initial carriage position A (see FIG. 3), which is an example of a reference position of the carriage 2. The reference white plate 10 is an example of a reference white plate for adjusting the reading density at which an image is read with the image sensor board 4.

The image reading device 101 includes an automatic document feeder (ADF) 102 mounted on an upper portion thereof, and a body portion of the image reading device 101 is coupled to the ADF 102 via a hinge or the like such that the ADF 102 can be opened and closed with respect to the contact glass 11. The ADF 102 includes a document tray serving as a document feed table on which a document bundle including a plurality of documents can be placed. The image reading device 101 also includes a separation and feed/conveyance mechanism including a document feed/conveyance roller that separates the documents one by one from the document bundle placed on the document tray and automatically feeds and conveys the document toward a conveyed document reading glass platen 9. The image reading device 101 may also have a configuration in which the ADF 102 is provided with another sensor to read both sides of a document during a single conveyance of the document. In this way, the image reading device 101 implements a document reading operation.

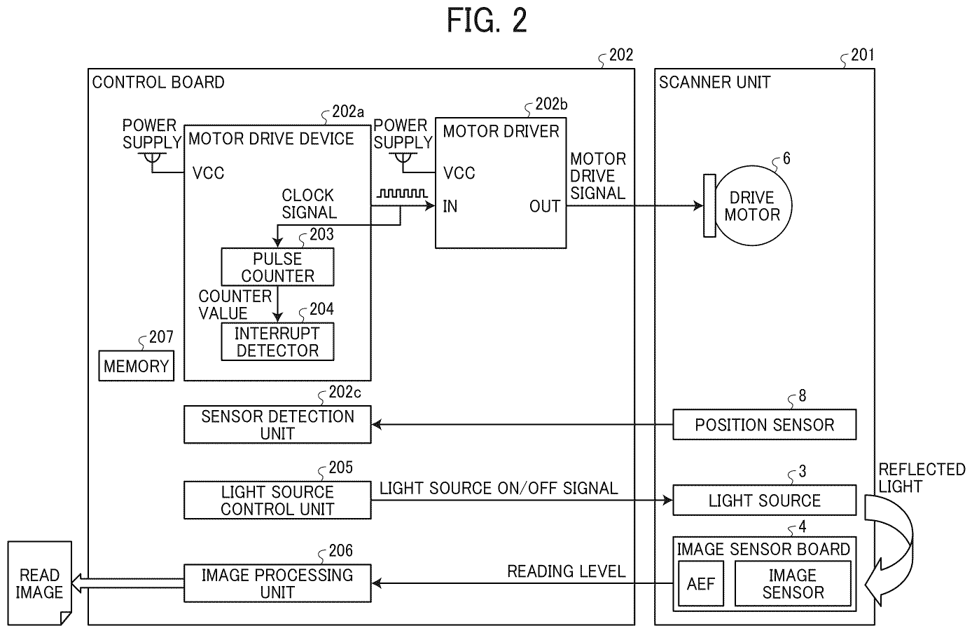

FIG. 2 is a block diagram illustrating an example of functions of the image reading device 101 according to the present embodiment. As illustrated in FIG. 2, the image reading device 101 according to the present embodiment includes a scanner unit 201 and a control board 202. The scanner unit 201 includes the drive motor 6, the position sensor 8, the light source 3, and the image sensor board 4, which are illustrated in FIG. 1. The control board 202 is separately provided as an input/output interface for various signals to and from the scanner unit 201. The control board 202 may be located inside the image reading device 101 or may be located in the main body of the digital multifunction peripheral, the digital copier, or the like.

The drive motor 6 is an example of a motor that drives the carriage 2. In the control board 202, a motor drive device 202a inputs input signals such as a clock signal, an enable signal, a direction signal, and a current adjustment signal to a motor driver 202b. In other words, the motor drive device 202a is an example of a motor drive device that generates a clock signal for the drive motor 6. In accordance with the input signals, the motor driver 202b outputs a motor drive signal for controlling the speed, the rotation direction, and the drive current to operate the drive motor 6. In other words, the motor driver 202b is an example of a motor driver that receives a clock signal from the motor drive device 202a and outputs a motor drive signal for driving the drive motor 6 in accordance with the clock signal. In response to receipt of the motor drive signal, the drive motor 6 rotates to control the carriage 2.

The motor drive device 202a is provided with a pulse counter 203 that counts the number of times a clock signal is input, and an interrupt detector 204 that generates an interrupt at any distance. The pulse counter 203 is an example of a pulse counter that counts the number of pulses of a clock signal generated by the motor drive device 202a. The interrupt detector 204 is an example of an interrupt detector that generates an interrupt in response to the number of pulses (counter value) counted by the pulse counter 203 reaching any set number of pulses. In the motor drive device 202a, the interrupt detector 204 determines the stop position of the carriage 2 and detects an abnormality in the operation of the carriage 2, based on the number of pulses counted by the pulse counter 203. A detailed abnormality detection method will be described below.

The position sensor 8 is typically a transmissive or reflective photosensor. The output of the position sensor 8 switches between low and high in accordance with the position of the carriage 2, and the logic of the position sensor 8 is received by a sensor detection unit 202c to determine the location of the carriage 2.

The light source 3 is typically a light emitting diode (LED) or a xenon lamp. The light source 3 receives a light source ON/OFF signal from a light source control unit 205 and turns on or off to input reflected light to the image sensor board 4. In the image sensor board 4, an image sensor receives the reflected light. The reflected light is converted from analog form to digital form in the image sensor board 4, and a reading level is transmitted to an image processing unit 206 in the subsequent stage. Then, various image corrections are performed, and a read image is output.

In the present embodiment, the operation of the carriage 2 by the drive motor 6 described above is to be detected by the position sensor 8, and no description will be given of details of an image generation method using the light source 3 and the image sensor board 4. The control board 202 includes a non-volatile memory 207 for storing, for example, various set values and the use conditions of devices. For example, the memory 207 may store information on an abnormality.

FIG. 3 is a diagram illustrating carriage operations of the image reading device 101 (i.e., scanner) according to the present embodiment. The following describes three typical operations of the carriage 2, which are performed in the scanner unit 201 illustrated in FIG. 2. The first operation is a home position return operation for returning the carriage 2 to the initial carriage position A. In a reference white plate reading operation and a document reading operation, which will be described below, if the initial carriage position A is offset, the value of the reference white plate 10 may be incorrectly read or the read document may be misaligned. Thus, typically, the home position return operation is performed to return the carriage 2 to the initial carriage position A before the reference white plate reading operation and the document reading operation.

In FIG. 3, first, when the carriage 2 is in the initial carriage position A, the carriage 2 is temporarily moved to a position-sensor OFF determination position b at which the position sensor 8 is in off position, moving in a direction in which the position sensor 8 is switched to the on position, and returns to the initial carriage position A. The initial carriage position A is defined at a position shifted from a position-sensor ON position B by a distance corresponding to a fixed value, and is set in advance in a system. The position-sensor ON position B is a position at which the position sensor 8 is turned on. The initial carriage position A is used as a reference position for all of the operations of the carriage 2.

When the home position return operation is performed while the carriage 2 is located to the right of the position-sensor OFF determination position b, the carriage 2 does not perform a reciprocating motion but instead performs a return motion. Specifically, as in the above description, the carriage 2 moves from the position-sensor ON position B, at which the position sensor 8 is turned on, by the distance corresponding to the fixed value and returns to the initial carriage position A.

The second operation is the reference white plate reading operation. The reference white plate reading operation is an operation for moving the carriage 2 to a position directly below the reference white plate 10 to acquire a white plate level (white plate data) and returning the carriage 2 to the initial carriage position A. The white plate level is read as a reference value for performing gain adjustment of the reading level or is used as a reference level for performing shading correction to correct variations in density across the document.

During the document reading operation described below, the carriage 2 reads the white plate level while performing scanning when passing through the reference white plate 10 before reading the document. In other cases, for example, when the light intensity and the gain are adjusted at the time of turning on the power of the system, or when the reference white plate 10 is read during continuous reading from the ADF 102, as illustrated in the upper portion of FIG. 3, the carriage 2 is moved to a reference white plate reading position C to perform an operation of reading the reference white plate 10.

The third operation is the document reading operation. The document reading operation is an operation for reading a document placed on the contact glass 11. In the document reading operation, the carriage 2 is moved from the initial carriage position A over a range determined by the length of the document (in the illustrated example, a movable range of the carriage 2 from a document reading start position D to a document reading end position E) through the reference white plate 10 to acquire document data, and after the document data is acquired, the carriage 2 returns to the initial carriage position A. The document reading end position E may be variable in accordance with the length of the document. At the reference white plate reading position C, the carriage 2 acquires the white plate level while performing scanning, and acquires a reference level for shading correction.

While the three main operations of the carriage 2 have been described, the presence or absence of an abnormality in the operation of the carriage 2 is determined by the ON or OFF logic of the position sensor 8.

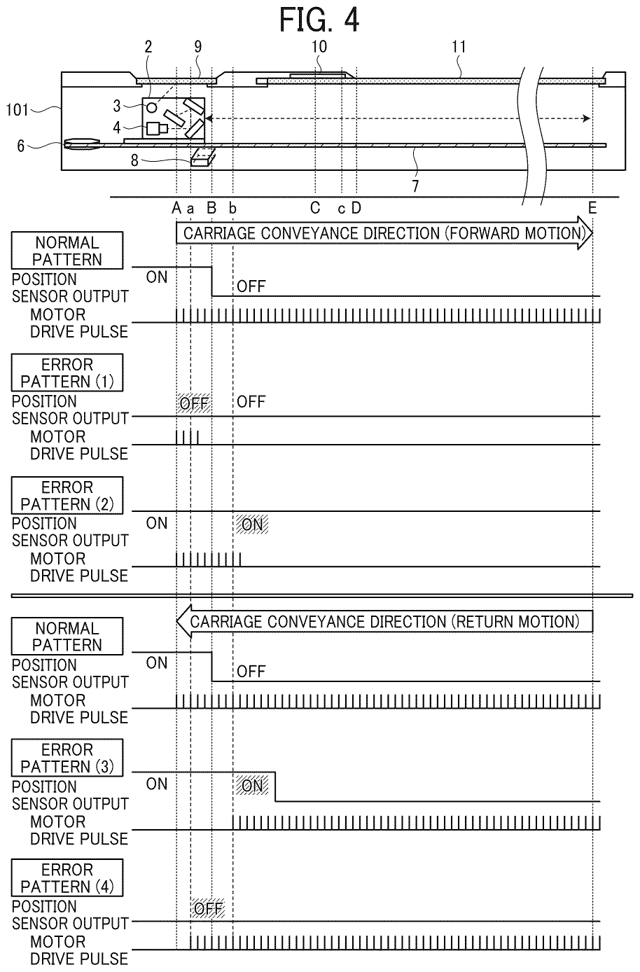

FIG. 4 is a diagram illustrating a method for determining an error in the operation of the carriage 2 in the image reading device 101 according to the present embodiment. During the document reading operation illustrated in FIG. 3, the carriage 2 performs reciprocal scanning. Specifically, during the document reading operation, the motor drive device 202a starts a forward scan of the carriage 2 from the initial carriage position A, and the position sensor 8 is turned off when the carriage 2 leaves the position-sensor ON position B. Then, the motor drive device 202a performs the reading of the reference white plate 10, which serves as a reference level for reading, starts reading the document at the document reading start position D, and ends reading the document at the document reading end position E. After the completion of the reading, the motor drive device 202a performs a return scan (return motion) of the carriage 2 from the document reading end position E to the initial carriage position A and returns the carriage 2 to the initial carriage position A.

An example of an error detection method for the carriage 2 will now be described. The motor drive device 202a designates a count value of the number of pulses of the drive motor 6 in advance and incorporates the count value in control software so that the interrupt detector 204 implements a determination interrupt at a position-sensor ON determination position a and the position-sensor OFF determination position b. In the forward scan (forward motion), the carriage 2 reaches the position-sensor ON determination position a immediately after the start of scanning. When the position sensor 8 is in the on position at the position-sensor ON determination position a, the motor drive device 202a determines that the carriage 2 is operating normally. When the position sensor 8 is in the off position at the position-sensor ON determination position a, the motor drive device 202a determines that the carriage 2 is operating abnormally, stops the operation of the carriage 2, and notifies the user of an error (error pattern (1)).

After passing through the position-sensor ON determination position a normally, the carriage 2 reaches the position-sensor OFF determination position b. When the carriage 2 reaches the position-sensor OFF determination position b after passing through the position sensor 8, the motor drive device 202a determines that the carriage 2 is operating normally if the position sensor 8 is turned off. However, when the position sensor 8 is in the on position, the motor drive device 202a determines that the carriage 2 is operating abnormally, stops the operation of the carriage 2, and notifies the user of an error (error pattern (2)).

Also in the return scan (return motion), when the carriage 2 returns to the position-sensor OFF determination position b, the motor drive device 202a determines that the carriage 2 is operating abnormally if the position sensor 8 is in the on position at the position-sensor OFF determination position b where the position sensor 8 should be in the off position since the carriage 2 has not reached the position sensor 8. Then, the motor drive device 202a stops the operation of the carriage 2 and notifies the user of an error (error pattern (3)).

After passing through the position-sensor OFF determination position b normally, when the carriage 2 returns to the position-sensor ON determination position a where the position sensor 8 should be turned on, if the position sensor 8 is in the off position, the motor drive device 202a determines that the carriage 2 is operating abnormally, stops the operation of the carriage 2, and notifies the user of an error (error pattern (4)). The motor drive device 202a performs the confirmation operation described above (detection of an abnormality in the operation of the carriage 2). When the carriage 2 passes through all the positions normally, the motor drive device 202a returns the carriage 2 to the initial carriage position A and ends the operation.

Whether the carriage 2 is operating normally is determined based on the above four error patterns, and an abnormality is usually notified to the user. While FIG. 4 illustrates an error detection method during the document reading operation illustrated in FIG. 3, the above-described method is also applicable to the home position return operation and the reference white plate reading operation illustrated in FIG. 3. Abnormalities determined based on the position sensor 8 may be caused by various factors, such as a failure of the position sensor 8, a failure of the drive motor 6, a failure of a device (the motor driver 202b) that outputs a motor operation signal, disconnection of a harness connecting the drive motor 6, and breakage of mechanical components (such as a gear and a belt) that operate the drive motor 6.

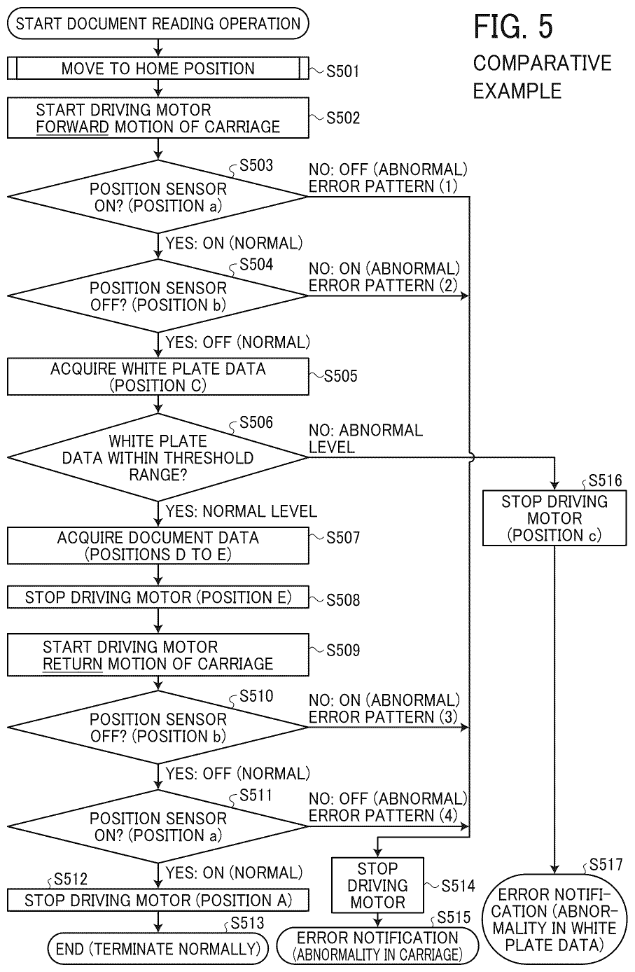

FIG. 5 is a flowchart illustrating an example of an error determination process for the carriage 2 during a document reading operation illustrated in FIG. 4. First, the motor drive device 202a moves the carriage 2 to the home position, which is the initial carriage position A (step S501). The movement to the home position illustrated in step S501 is an operation of returning the carriage 2 to the initial carriage position A, as described with reference to FIG. 3, and a description of the internal process flow will be omitted. Then, the motor drive device 202a starts driving the drive motor 6 and performs a forward scan (forward motion) of the carriage 2 (step S502). Then, the motor drive device 202a determines whether the position sensor 8 is in the on position at the position-sensor ON determination position a (step S503). If the position sensor 8 is in the off position at the position-sensor ON determination position a (step S503: No), the motor drive device 202a stops driving the drive motor 6 (step S514), detects an abnormality in the carriage 2 (error pattern (1)), and issues an error notification (step S515).

If the position sensor 8 is in the on position at the position-sensor ON determination position a (step S503: Yes), the motor drive device 202a determines whether the position sensor 8 is in the off position at the position-sensor OFF determination position b (step S504). If the position sensor 8 is in the on position at the position-sensor OFF determination position b (step S504: No), the motor drive device 202a stops driving the drive motor 6 (step S514), detects an abnormality in the carriage 2 (error pattern (2)), and issues an error notification (step S515).

If the position sensor 8 is in the off position at the position-sensor OFF determination position b (step S504: Yes), the motor drive device 202a moves the carriage 2 to the reference white plate reading position C to acquire white plate data (step S505). Then, the motor drive device 202a determines whether the acquired white plate data (i.e., the white plate level) is within a threshold range (step S506). If the acquired white plate data indicates an abnormal level outside the threshold range (step S506: No), the motor drive device 202a stops the drive motor 6 at a reference white plate error carriage stop position c (step S516), detects an abnormality in the white plate data, and issues an error notification (step S517).

If the acquired white plate data indicates a normal level within the threshold range (step S506: Yes), the motor drive device 202a moves the carriage 2 from the document reading start position D to the document reading end position E to acquire document data (image) (step S507). Then, the motor drive device 202a stops driving the drive motor 6 at the document reading end position E (step S508). Then, the motor drive device 202a starts driving the drive motor 6 and performs a return scan (return motion) of the carriage 2 (step S509).

Then, the motor drive device 202a determines whether the position sensor 8 is in the off position at the position-sensor OFF determination position b (step S510). If the position sensor 8 is in the on position at the position-sensor OFF determination position b (step S510: No), the motor drive device 202a stops driving the drive motor 6 (step S514), detects an abnormality in the carriage 2 (error pattern (3)), and issues an error notification (step S515).

If the position sensor 8 is in the off position at the position-sensor OFF determination position b (step S510: Yes), the motor drive device 202a determines whether the position sensor 8 is in the on position at the position-sensor ON determination position a (step S511). If the position sensor 8 is in the off position at the position-sensor ON determination position a (step S511: No), the motor drive device 202a stops driving the drive motor 6 (step S514), detects an abnormality in the carriage 2 (error pattern (4)), and issues an error notification (step S515).

If the position sensor 8 is in the on position at the position-sensor ON determination position a (step S511: Yes), the motor drive device 202a stops driving the drive motor 6 at the initial carriage position A (step S512), and terminates the operation of the carriage 2 normally (step S513).

As described with reference to FIG. 4, in each of the forward motion and the return motion of the carriage 2, error determination based on the error patterns (1) to (4) is performed at the position-sensor ON determination position a and the position-sensor OFF determination position b (steps S503, S504, S510, and S511). In a normal state where no error occurs, in the forward motion, the carriage 2 acquires white plate data at the reference white plate reading position C during the carriage operation and acquires document data in an interval from the document reading start position D to the document reading end position E. Then, the carriage 2 stops at the document reading end position E, and the return motion of the carriage 2 starts. In the return motion, the carriage 2 returns to the initial carriage position A, which is a reference position. Thus, the operation is completed normally (steps S501 to S513).

If the carriage 2 is determined to have an error based on any one of the error patterns (1) to (4), the driving of the drive motor 6 is stopped, and an error notification is issued (steps S514 and S515). At this time, to notify the user of the abnormality, an error notification is displayed on an operation panel screen 300 to prompt the user to turn off the power of the machine and turn on the power again, or a screen for prompting the user to make an inquiry to a service engineer is displayed. Some machines have a reboot function for automatically turning the power of the machine from off to on to restore the system.

The process also branches based on whether the white plate data is within the threshold range (step S506). Specifically, it is determined whether the white plate data of the reference white plate 10 read when the carriage 2 passes through the reference white plate reading position C is normal. If the white plate data indicates an abnormality, the driving of the drive motor 6 is stopped, and the user is notified of the abnormality (steps S516 and S517). In this case, since the white plate data is acquired during the operation of the carriage 2, due to a time lag during deceleration before the carriage 2 comes to a complete stop, the carriage 2 is stopped at the reference white plate error carriage stop position c rather than the reference white plate reading position C illustrated in FIG. 4.

There is an abnormality in the white plate data of the reference white plate 10 due to certain factors. For example, a failure occurs after the carriage 2 passes the position-sensor OFF determination position b in the forward motion, causing the carriage 2 to fail to reach the position directly below the reference white plate 10 normally, and data may be read at a position other than the position directly below the reference white plate 10. Another possible factor is that the light source 3 and the optical system such as the image sensor are abnormal.

The typical process for determining an error during the document reading operation illustrated in the flowchart of FIG. 5 may encounter some issues. For example, even in the case of a temporary error that does not involve a service engineer for repair due to an external factor (e.g., an external impact), the user is notified of the error and is caused to turn the power of the machine from off to on to use the machine again or caused to contact the service engineer, causing downtime during which the user is unable to use the machine and making the user feel stress.

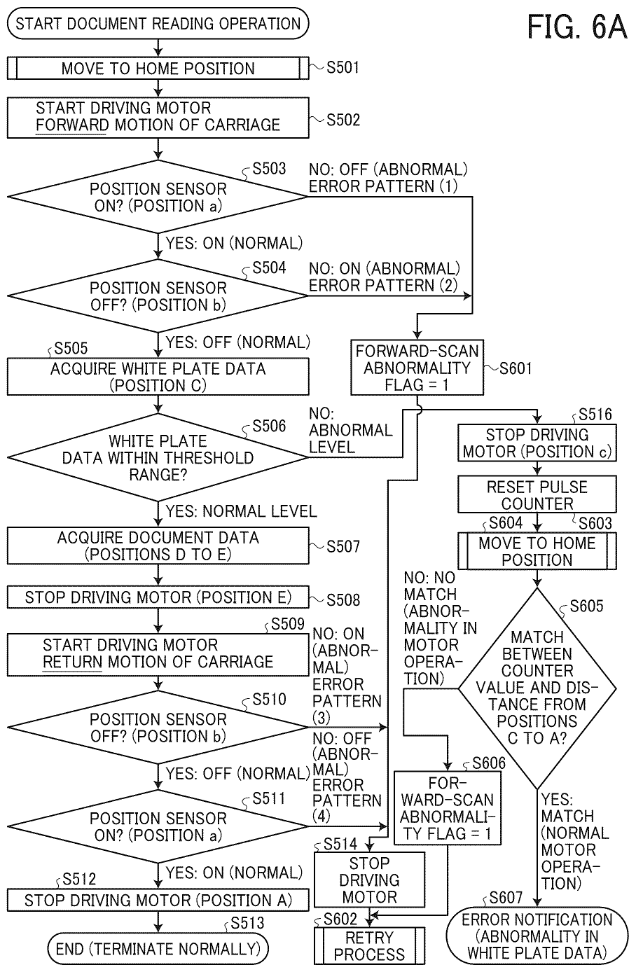

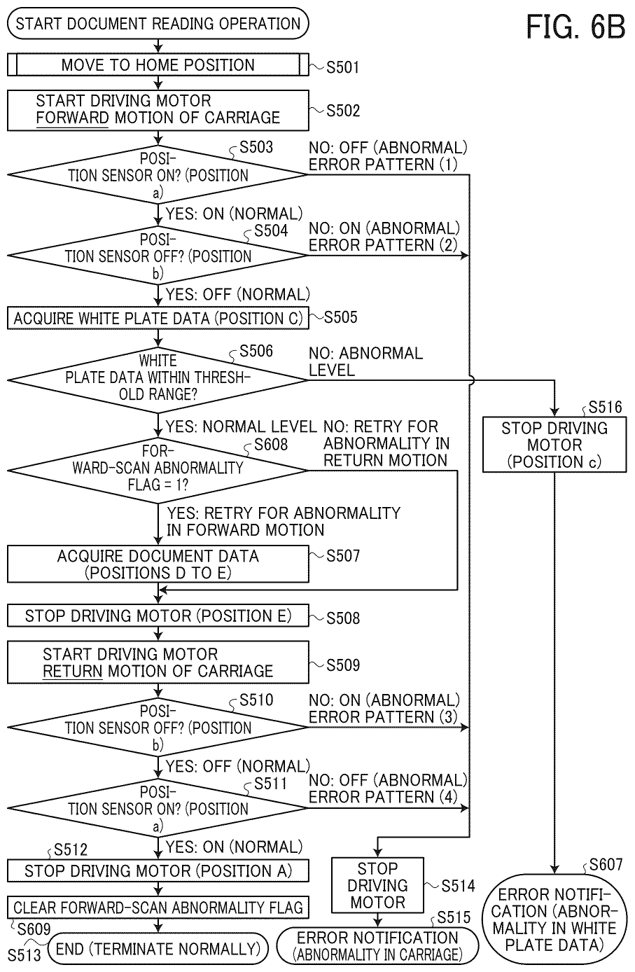

FIG. 6A is a flowchart illustrating an example of an error determination process for the carriage 2 during the document reading operation according to the present embodiment. In the following, descriptions of processes similar to those of FIG. 5 will be omitted. In the present embodiment, if the position sensor 8 is in the off position at the position-sensor ON determination position a (step S503: No) and if the position sensor 8 is in the on position at the position-sensor OFF determination position b (step S504: No), the motor drive device 202 a sets a forward-scan abnormality flag to 1 (step S601). The forward-scan abnormality flag is a flag indicating an abnormality in the forward scan of the carriage 2. Then, the motor drive device 202a stops driving the drive motor 6 (step S514), and then executes a retry process (step S602).

In the present embodiment, if the acquired white plate data indicates an abnormal level outside the threshold range (step S506: No), the motor drive device 202a stops the drive motor 6 at the reference white plate error carriage stop position c (step S516), resets the pulse counter 203 (step S603), and moves the carriage 2 to the initial carriage position A (step S604). Then, the motor drive device 202a determines whether the number of pulses corresponding to the distance from the reference white plate error carriage stop position c to the initial carriage position A matches the number of pulses (counter value) counted by the pulse counter 203 (step S605).

If the number of pulses corresponding to the distance from the reference white plate error carriage stop position c to the initial carriage position A matches the number of pulses (counter value) counted by the pulse counter 203 (step S605: Yes), the motor drive device 202a determines that the drive motor 6 is operating normally, and notifies the user of an abnormality in the white plate data (step S607). On the other hand, if the number of pulses corresponding to the distance from the reference white plate error carriage stop position c to the initial carriage position A does not match the number of pulses (counter value) counted by the pulse counter 203 (step S605: No), the motor drive device 202a sets the forward-scan abnormality flag, which indicates an abnormality in the forward scan of the carriage 2, to 1 (step S606).

The normal operation performed when no abnormality occurs in the carriage 2 (steps S501 to S513) is exactly the same as that in the typical process illustrated in the flowchart of FIG. 5. Unlike the flowchart illustrated in FIG. 5, in the flowchart of the document reading operation illustrated in FIG. 6A, the user is not notified of an error immediately after the error is determined based on the error patterns (1) to (4), but in the flowchart of the retry process illustrated in FIG. 6B, the document reading operation is performed again in order to prevent error notification in response to a single error (step S602).

FIG. 6B is a flowchart illustrating an example of the retry process during the document reading operation according to the present embodiment. In the following, descriptions of processes similar to those of FIG. 5 will be omitted.

In the retry process during the document reading operation, if the acquired white plate data (i.e., the white plate level) is within the threshold range (step S506: Yes), the motor drive device 202 a determines whether the forward-scan abnormality flag is set to 1 (step S608). If the forward-scan abnormality flag is not set to 1 (step S608: No), in step S508, the motor drive device 202a detects an abnormality in the carriage 2 in the return motion. On the other hand, if the forward-scan abnormality flag is set to 1 (step S608: Yes), the motor drive device 202a moves the carriage 2 from the document reading start position D to the document reading end position E to acquire document data (image) (step S507). Then, the motor drive device 202a stops driving the drive motor 6 at the document reading end position E (step S508).

If the position sensor 8 is in the on position at the position-sensor ON determination position a (step S511: Yes), the motor drive device 202a stops driving the drive motor 6 at the initial carriage position A (step S512), clears the forward-scan abnormality flag (step S609), and terminates the operation of the carriage 2 normally (step S513).

In the flowchart of the retry process illustrated in FIG. 6B, the document reading operation is performed again, as in the flowchart of the typical process illustrated in FIG. 5. In FIG. 6B, steps S608 and S609 are added. Accordingly, even if a carriage error is identified once, the retry process is performed to attempt a recovery, and the document reading operation can be performed if no error occurs in the retry process. That is, the motor drive device 202a determines whether there is an abnormality in the carriage 2, based on the number of pulses counted by the pulse counter 203 and the logic of the position sensor 8, and in a case where it is determined that there is an abnormality in the carriage 2, the motor drive device 202a performs a re-scanning operation of the carriage 2 to perform a scanning operation again in a direction in which the logic of the position sensor 8 changes. The re-scanning operation performs another reciprocal scanning of the carriage 2 at a moving distance equal to or longer than the moving distance at which the immediately preceding scanning operation of the carriage 2 is performed normally. The term “logic of the position sensor 8” may be used to indicate that the position sensor 8 is turned on in response to detection of the carriage 2 at the initial carriage position A and is turned off in response to detection of movement of the carriage 2 from the initial carriage position A.

An image reading device includes an image sensor (e.g., the image sensor board 4) to read an image on an object; and a light source 3 to emit light to the object; a carriage 2; a position sensor 8; a motor (e.g., the drive motor 6); and circuitry (i.e., the control board 202). The carriage 2 is movable in a forward direction and a return direction opposite to the forward direction; and performs a first reciprocal scanning operation starting from a first position (A). The carriage 2 mounts at least one of the image sensor or the light source. The position sensor detects the carriage, in the forward direction, at the first position; and a second position different from the first position; and switches a ON/OFF state between ON and OFF in accordance with a detection of the carriage at the second position. The motor moves the carriage to perform a first reciprocal scanning operation. The circuitry generates a clock signal to generate a drive signal; outputs, to the motor, the drive signal in accordance with the clock signal to drive the motor to move the carriage; counts a number of pulses of the clock signal; determines whether the carriage has an abnormality (S503, S504) based on the number of pulses of the clock signal and the ON/OFF state of the position sensor; and causes the motor to, when the circuitry determines that the carriage has the abnormality (S503, S504: NO): move the carriage back to the first position (S501) in the return direction; move the carriage in the forward direction to change the ON/OFF state of the position sensor to perform a second reciprocal scanning operation (S502). The circuitry further moves the carriage a first moving distance in the first reciprocal scanning operation; and moves the carriage a second moving distance, equal to or greater than the first moving distance, in the second reciprocal scanning operation.

In the method for detecting an abnormality in the driving of the carriage 2, therefore, even if an abnormality occurs during reading of a document or during reading of the reference white plate 10, the abnormality is identified as being caused by the optical system or by the driving of the carriage 2. If the abnormality is determined to be caused by the driving of the carriage 2, whether the abnormality is recoverable is automatically determined such that the operation of turning the power of the image reading device 101 from off to on is not performed in the case of a recoverable abnormality. This shortens the downtime during which the user is unable to use the image reading device 101.

In the flowchart of the document reading operation illustrated in FIG. 6A, also when the white plate data is determined to indicate an abnormal level in the processing of determining whether the white plate data is within the threshold range (step S506), a process flow for identifying whether the abnormality is caused by the carriage 2 or the optical system is also added (steps S605 to S607). In one method for identifying whether the abnormality is caused by the carriage 2 or the optical system, if the white plate data indicates an abnormality, the drive motor 6 is stopped at the reference white plate error carriage stop position c illustrated in FIG. 4, and then the pulse counter 203 for the drive motor 6 is reset and counts carriage pulses until the carriage 2 returns to the home position (i.e., the initial carriage position A). Since the distance from the reference white plate error carriage stop position c to the initial carriage position A is fixed, the ideal value of the number of pulses is known. Thus, the number of pulses actually generated when the carriage 2 is returned from the reference white plate error carriage stop position c to the initial carriage position A is counted and compared with the ideal value. If the number of pulses matches the ideal value, it can be determined that there is no abnormality in the carriage 2, and thus, it is determined that the abnormality is caused by the optical system, immediately after which the user is notified of the error. However, if the number of pulses does not match the ideal value, it is determined that the abnormality is caused by the carriage 2, and the retry process illustrated in the flowchart of FIG. 6B is performed to allow for recovery when the abnormality is sudden.

That is, during reading of the reference white plate 10, if it is determined that the reference white plate 10 is at an abnormal level based on the white plate data (an example of reading level) of the reference white plate 10, the motor drive device 202a compares the number of pulses counted when the carriage 2 is returned to the initial carriage position A with an ideal value. If it is determined that the abnormal level is caused by an abnormality in the carriage 2, the motor drive device 202a performs another reciprocal scanning of the carriage 2 and determines whether there is an abnormality in the carriage 2. This configuration enables a distinction between an abnormality caused by the optical system and an abnormality caused by the carriage 2, and can further reduce the downtime for the user.

When an error occurs in the carriage 2 based on the error pattern (1) or (2) or an abnormality in the white plate data of the reference white plate 10, the forward-scan abnormality flag is set (steps S601 and S606). The forward-scan abnormality flag is set in order to identify whether the abnormality is caused in the forward motion of the carriage 2 or the return motion of the carriage 2 to determine whether to acquire document data again in the retry process. In a case where an error is detected in the forward motion of the carriage 2, document data has not yet been acquired in the flowchart illustrated in FIG. 6A. If no error is detected in the retry process illustrated in FIG. 6B, document data is acquired when the forward-scan abnormality flag is set. This allows the user to perform the scanning operation without performing the operation procedure for reading the document again.

If the document reading operation is performed again in a case where an error is detected in the return motion of the carriage 2 based on the error pattern (3) or (4), the acquisition of document data has been completed in the flowchart illustrated in FIG. 6A, and the system has performed a process for scanning or copying. In the case of copying, a copy image has been generated. Copies are generally charged at a price per copy. Thus, acquisition of document data again in the flowchart illustrated in FIG. 6B may lead to an unintended charge. To avoid the unintended charge, in the case of an abnormality in the return motion of the carriage 2, a branch (step S608) for determining whether the forward-scan abnormality flag is set to 1 is provided, and the generation of document data is not performed. When the retry process illustrated in FIG. 6B is successfully completed, the forward-scan abnormality flag is cleared (step S609).

That is, the motor drive device 202a determines whether there is an abnormality in the carriage 2 during the document reading operation. If it is determined that there is an abnormality in a forward scan of the carriage 2, image reading is performed during another reciprocal scanning of the carriage 2. If it is determined that there is an abnormality in a return scan of the carriage 2, image reading is not performed during another reciprocal scanning of the carriage 2. This allows the reading operation to be performed without requesting the user to perform an operation again. In addition, if an error has occurred after the document has been read, the reading process is not performed, thus preventing the user from being charged.

In the image reading device 101, the circuitry determines whether the carriage has the abnormality when the image sensor reads the image on the object in the first reciprocal scanning operation as a reading operation; and determines whether the carriage has the abnormality when circuitry moves the carriage in the forward direction in the reading operation as a forward abnormality; or when circuitry moves the carriage in the return direction in the reading operation as a return abnormality. The circuitry further performs the image reading when the circuitry determines that the carriage has the forward abnormality; and does not perform the image reading when the circuitry determines that the carriage has the return abnormality.

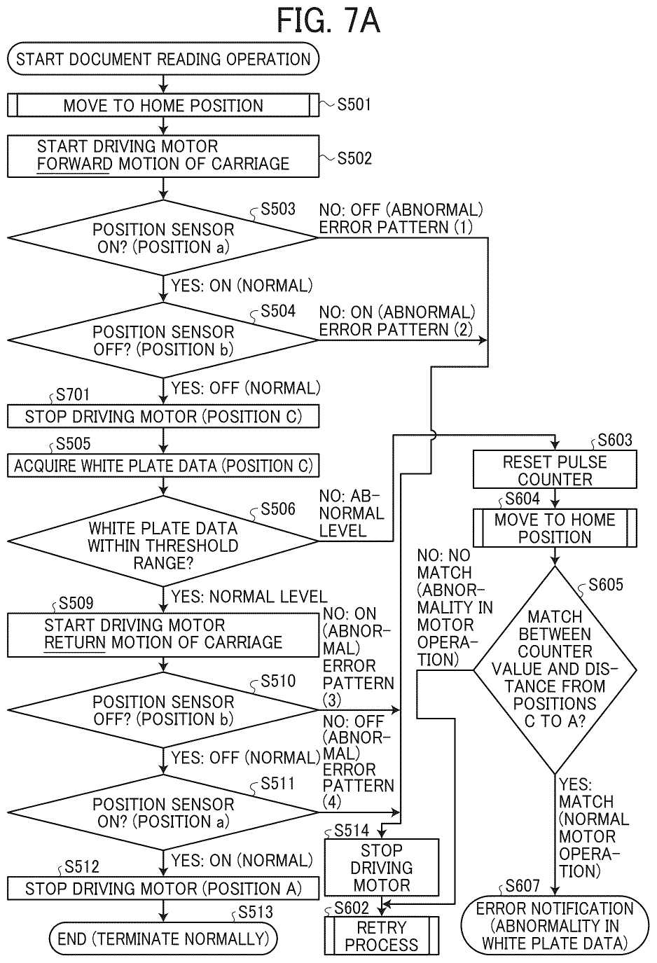

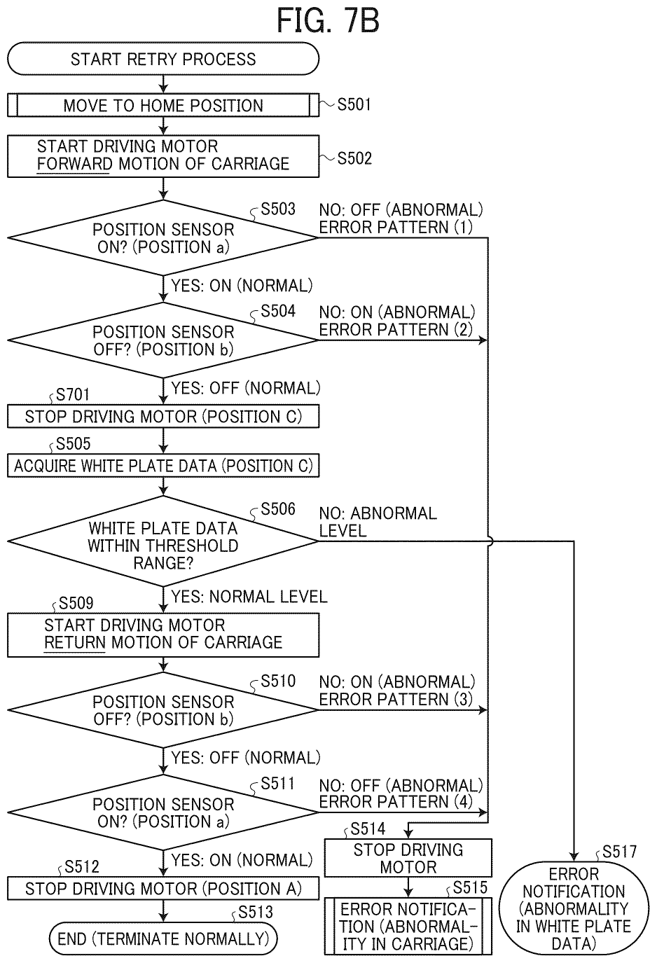

FIG. 7A is a flowchart illustrating an example of an error determination process for the carriage 2 during the reference white plate reading operation according to the present embodiment. FIG. 7B is a flowchart illustrating an example of a retry process during the reference white plate reading operation according to the present embodiment. In the following, descriptions of processes similar to those of FIGS. 5, 6A, and 6B will be omitted. As described with reference to the carriage operations illustrated in FIG. 3, the operations of the carriage 2 include an operation of reading white plate data and a reciprocating motion up to the position directly below the reference white plate 10 (i.e., the reference white plate reading position C). In the present embodiment, the retry process can be performed for a scanning operation of the carriage 2 in which the carriage 2 moves across the position sensor 8, in addition to the document reading operation illustrated in FIGS. 6A and 6B.

As illustrated in FIG. 7A, during the reference white plate reading operation, if the position sensor 8 is in the off position at the position-sensor OFF determination position b (step S504: Yes), the motor drive device 202a moves the carriage 2 to the reference white plate reading position C and stops the carriage 2 at the reference white plate reading position C (step S701). Then, the process proceeds to step S505. If the acquired white plate data indicates an abnormal level outside the threshold range (step S506: No), the process proceeds to step S603, and the motor drive device 202a resets the pulse counter 203.

The image reading device 101 further includes a reference white plate 10 to adjust a density of the image read by the image sensor (i.e., the image sensor board 4). The circuitry further causes the motor to move the carriage to a third position to read the reference white plate; and obtain a reading level of the reference white plate. The circuitry determines (S506) whether the reading level of the reference white plate 10 is within a predetermined threshold range, causes (S604) the motor to move the carriage back to the first position in the return direction when the reading level is not within the predetermined threshold range, counts the number of pulses when the carriage is moved backed to the first position, and compares (S605) the number of pulses counted with an ideal value. The circuitry further determines (S605) the abnormality of the carriage based on a comparison between the number of pulses counted and the ideal value, causes (S502) the motor to move the carriage in the forward direction to perform the second reciprocal scanning operation when the circuitry determines that the carriage (2) has the abnormality, and determines (S503) whether the carriage has the abnormality again.

As illustrated in FIG. 7B, in the retry process during the reference white plate reading operation, if the acquired white plate data indicates an abnormal level outside the threshold range (step S506: No), the process proceeds to step S517 without causing the motor drive device 202a to stop the carriage 2 at the reference white plate error carriage stop position c.

The differences between FIGS. 6A and 6B and FIGS. 7A and 7B are as follows:
Reading of the document is not performed, and the count value for the optical system used for the comparison (step S605) when the white plate data indicates an abnormal level outside the threshold range (step S506: No) is based on the number of pulses corresponding to the distance from the reference white plate reading position C to the initial carriage position A. Accordingly, the process flow for identifying whether the abnormality is caused by the carriage 2 or the optical system is also applicable to the reference white plate reading operation, and recovery is allowed for when the abnormality is sudden. That is, the operation of determining whether there is an abnormality in the carriage 2 and performing another reciprocal scanning of the carriage 2 is also applied to the reciprocal scanning of the carriage 2 up to the reference white plate 10.

In the image reading device 101, the circuitry determines whether the carriage has the abnormality; and performs the second reciprocal scanning operation, when the circuitry moves the carriage to the reference white plate.

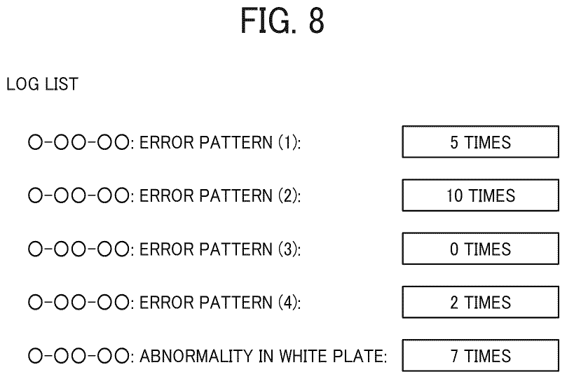

FIG. 8 is a diagram illustrating an example of the display of an error log screen according to the present embodiment. Errors based on the error patterns in the flowcharts illustrated in FIGS. 6A, 6B, 7A, and 7B or an abnormality in the reference white plate 10 is not displayed to the user as long as the errors or abnormality can be recovered by the retry process. However, an error that has actually occurred may be counted, and the number of errors may be stored in an internal memory. The storage of the errors or the abnormality that has actually been recovered by the retry process can be used for failure analysis to predict the cause of a failure that occurs. As illustrated in FIG. 2, the control board 202 includes the non-volatile memory 207. Thus, an error log can be left in the control board 202. That is, the motor drive device 202a stores, in the memory 207, a history of abnormalities determined to have occurred in the carriage 2. As a result, the frequency of abnormalities determined to have occurred in the market can be checked and used for failure prediction and analysis.

In the image reading device 101, the circuitry stores, in a memory, a history of abnormalities of the carriage 2.

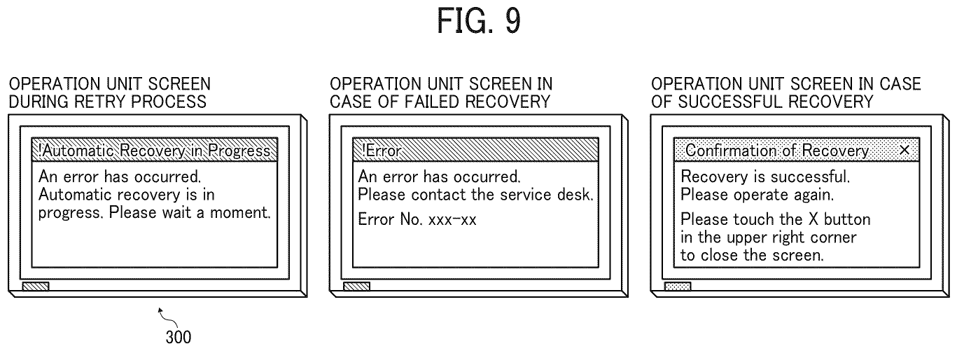

FIG. 9 is a diagram illustrating examples of an operation panel screen 300 according to the present embodiment. When the retry process is performed due to a sudden error, the behavior of the image reading device 101, such as a scanner, appears different to the user than usual, and the user experiences a waiting time of about several seconds during the unusual operation of the image reading device 101. To alleviate any concern that the user has during the waiting time, an automatic recovery screen may be displayed on an operation panel screen 300 during the retry process performed by the machine. If recovery is not successful in the retry process, an error message may be displayed. If recovery is successful, a message indicating the successful recovery may be displayed. The display of such messages can reduce the user's concern. That is, the image reading device 101 may have an operation panel screen 300 for displaying a screen pattern to be notified to the user during a determination of whether there is an abnormality in the carriage 2. Thus, appropriate countermeasures can be presented to the user.

The image reading device 101 further includes an operation panel screen 300. The circuitry controls the operation panel screen to display a screen pattern of the abnormality of the carriage, when the circuitry determines that the carriage 2 has the abnormality (S503, S504).

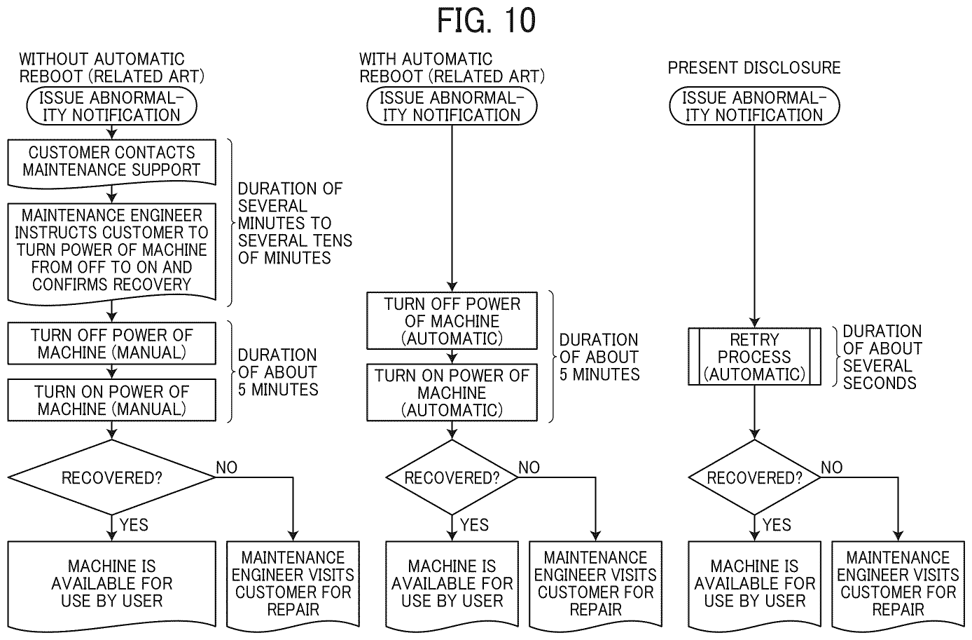

FIG. 10 is a diagram illustrating an example of an effect of the present embodiment. A recent machine such as a multifunction peripheral has an automatic reboot function for automatically turning the power of the machine from off to on when an error occurs to attempt to recover the machine from the error. In the related art, when an abnormality occurs in a machine without the automatic reboot function, a customer usually contacts the manufacturer's maintenance support directly by telephone, and then the maintenance engineer visits the customer to perform the recovery operation, or instructs the customer to turn the power of the machine from off to on to restart the machine over the telephone and confirms recovery. This series of operations involves a process for at least the customer to contact the maintenance support, and the process is inefficient and takes about several tens of minutes.

When an abnormality occurs in a machine with the automatic reboot function, the machine automatically turns the power from off to on once. Thus, the time-consuming process for the customer to contact the maintenance support is eliminated. However, since it takes about several minutes for the machine to turn the power from off to on, it is difficult to perform copying or scanning immediately after the error has occurred, which causes stress to the customer. According to the present embodiment, the retry process can address the issue described above, and involves a time of about several seconds. Thus, even if an abnormality occurs, the time taken for recovery can be minimized.

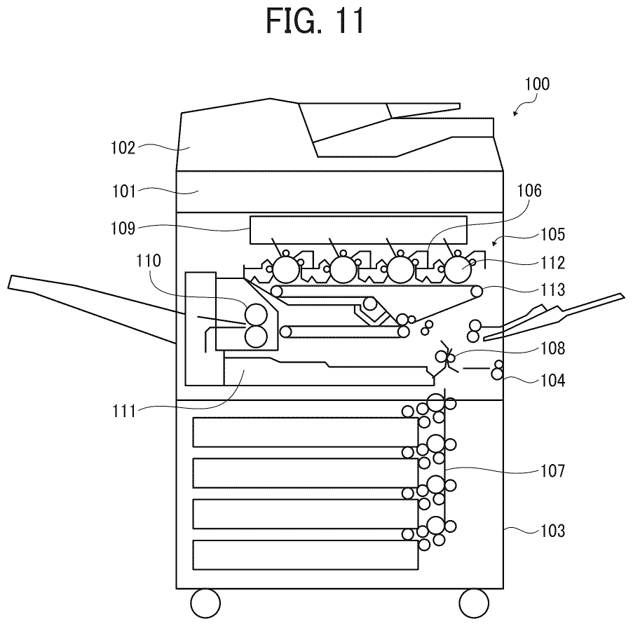

FIG. 11 is a diagram illustrating an example of an image forming apparatus 100 including the image reading device 101 according to the present embodiment. While the foregoing description is directed to the image reading device 101, a function of performing a reading operation using the image reading device 101 according to the present embodiment may be applied to a copy function or a facsimile function of an image forming apparatus, in addition to a scan operation. The image forming apparatus 100 illustrated in FIG. 11 is an apparatus having copy, scan, and facsimile capabilities.

The image forming apparatus 100 basically includes a paper feed unit 103, an image forming apparatus body 104, the scanner (i.e., image reading device) 101, and the ADF 102. The image forming apparatus body 104 is an example of an image former that forms an image read by the scanner 101 on recording paper. The image forming apparatus body 104 includes a tandem image formation unit 105, a registration roller 108 that supplies recording paper from the paper feed unit 103 to the image formation unit 105 along a conveyance path 107, an optical writing device 109, a fixing and conveyance unit 110, and a duplex tray 111.

The image formation unit 105 includes four photoconductor drums 112 arranged inline so as to correspond to four colors of yellow (Y), magenta (M), cyan (C), and black (K), and image formation elements including a charger, a developing device 106, a transfer device, a cleaner, and a charge remover are arranged around each of the photoconductor drums 112. An intermediate transfer belt 113, which is stretched over a driving roller and a driven roller, is arranged between the transfer devices and the photoconductor drums 112 with nips therebetween, and is held in the nips.

In the tandem image forming apparatus 100 having the configuration described above, optical writing is performed on the photoconductor drums 112 of the respective colors of yellow (Y), magenta (M), cyan (C), and black (K) to form latent images, and the latent images are then developed with the corresponding color toners by the developing devices 106 to form toner images. The toner images are transferred onto the intermediate transfer belt 113 through a primary transfer in the order of, for example, yellow (Y), magenta (M), cyan (C), and black (K). The four color images are superimposed by primary transfer to form a full color image, and the full color image is transferred onto the recording paper through a secondary transfer and fixed on the recording paper. Then, the recording paper on which the image is fixed is ejected. As a result, the recording paper with the image formed thereon is obtained. The image reading device 101 according to the present embodiment is included in the image forming apparatus 100. This configuration can reduce the downtime of the image forming apparatus 100 as compared to a conventional machine.

An image forming apparatus 100 includes the image reading device and an image former 104 to form an image read by the image reading device 101 on a medium.

As described above, according to the image reading device 101 of the present embodiment, in a method for detecting an abnormality in the driving of the carriage 2, even if an abnormality occurs during reading of a document or during reading of the reference white plate 10, the abnormality is identified as being caused by the optical system or by the driving of the carriage 2. If the abnormality is determined to be caused by the driving of the carriage 2, whether the abnormality is recoverable is automatically determined such that the operation of turning the power of the image reading device 101 from off to on is not performed in the case of a recoverable abnormality. This shortens the downtime during which the user is unable to use the image reading device 101.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

For example, aspects of the present disclosure include the following.

In a first aspect, an image reading device includes an image sensor, a light source, a carriage, a position sensor, a motor, a motor drive device, a motor driver, and a pulse counter. The image sensor reads an image of an object. The light source irradiates the object with light. The carriage performs reciprocal scanning along a one-dimensional direction. The carriage includes at least one of the image sensor or the light source. The position sensor detects a reference position of the carriage. The motor drives the carriage. The motor drive device generates a clock signal for the motor. The motor driver outputs a motor drive signal for driving the motor to the motor in accordance with the clock signal generated by the motor drive device. The pulse counter counts a number of pulses of the clock signal generated by the motor drive device. In a case where it is determined that there is an abnormality in the carriage based on the number of pulses counted by the pulse counter and a logic of the position sensor, the motor drive device performs a re-scanning operation of the carriage to perform a scanning operation again in a direction in which the logic of the position sensor changes. The re-scanning operation performs another reciprocal scanning of the carriage at a moving distance equal to or longer than a moving distance at which an immediately preceding scanning operation of the carriage is performed normally.

According to a second aspect, the image reading device of the first aspect further includes a reference white plate. The reference white plate adjusts a density at which the image sensor reads the image. During reading of the reference white plate, in a case where it is determined that the reference white plate is at an abnormal level based on a reading level of the reference white plate, the motor drive device compares the number of pulses counted when the carriage is returned to the reference position with an ideal value. In a case where it is determined that the abnormal level is caused by an abnormality in the carriage, the motor drive device performs another reciprocal scanning of the carriage and determines whether there is an abnormality in the carriage.

According to a third aspect, in the image reading device of the first aspect or the second aspect, the motor drive device determines whether there is an abnormality in the carriage during a document reading operation, in a case where it is determined that there is an abnormality during a forward scan of the carriage, the image is read during another reciprocal scanning of the carriage, and in a case where it is determined that there is an abnormality during a return scan of the carriage, the image is not read during another reciprocal scanning of the carriage.

According to a fourth aspect, in the image reading device of the second aspect, an operation of determining whether there is an abnormality in the carriage and performing another reciprocal scanning of the carriage is also applied to reciprocal scanning of the carriage up to the reference white plate.

According to a fifth aspect, in the image reading device of any one of the first to fourth aspects, the motor drive device stores, in a memory, a history of abnormalities determined to have occurred in the carriage.

According to a sixth aspect, the image reading device of any one of the first to fifth aspects further includes an operation panel screen. The operation panel screen displays a screen pattern to be notified to a user during a determination of whether there is an abnormality in the carriage.

According to a seventh aspect, the image reading device of any one of the first to sixth aspects includes at least one of a copy printing function, a scanner transmission function, or a facsimile transmission function.

In an eighth aspect, an image forming apparatus includes the image reading device of any one of the first to seventh aspects, and an image former. The image former forms an image read by the image reading device on recording paper.

1. An image reading device comprising:
an image sensor to read an image on an object; and
a light source to emit light to the object;
a carriage:
movable in a forward direction and a return direction opposite to the forward direction; and
performs a first reciprocal scanning operation starting from a first position,
the carriage mounting at least one of:
the image sensor; or
the light source;
a position sensor to:
detect the carriage, in the forward direction, at:
the first position; and
a second position different from the first position; and
switch a ON/OFF state between ON and OFF in accordance with a detection of the carriage at the second position;
a motor to move the carriage to perform the first reciprocal scanning operation; and
circuitry configured to:
generate a clock signal to generate a drive signal;
output, to the motor, the drive signal in accordance with the clock signal to drive the motor to move the carriage;
count a number of pulses of the clock signal;
determine whether the carriage has an abnormality based on:
the number of pulses of the clock signal; and
the ON/OFF state of the position sensor; and
cause the motor to, when the circuitry determines that the carriage has the abnormality:
move the carriage back to the first position in the return direction; and
move the carriage in the forward direction to change the ON/OFF state of the position sensor to perform a second reciprocal scanning operation,
wherein the circuitry is further configured to:
move the carriage a first moving distance in the first reciprocal scanning operation; and
move the carriage a second moving distance, equal to or greater than the first moving distance, in the second reciprocal scanning operation.

2. The image reading device according to claim 1, further comprising:
a reference white plate to adjust a density of the image read by the image sensor, wherein
the circuitry is further configured to:
cause the motor to move the carriage to a third position to:
read the reference white plate; and
obtain a reading level of the reference white plate;
determine whether the reading level of the reference white plate is within a predetermined threshold range;
cause the motor to move the carriage back to the first position in the return direction when the reading level is not within the predetermined threshold range;
count the number of pulses when the carriage is moved backed to the first position;
compare the number of pulses counted with an ideal value;
determine the abnormality of the carriage based on a comparison between the number of pulses counted and the ideal value;
cause the motor to move the carriage in the forward direction to perform the second reciprocal scanning operation when the circuitry determines that the carriage has the abnormality; and
determine whether the carriage has the abnormality again.

3. The image reading device according to claim 1,
wherein the circuitry is further configured to:
determine whether the carriage has the abnormality when the image sensor reads the image on the object in the first reciprocal scanning operation as a reading operation;
determine whether the carriage has the abnormality:
when circuitry moves the carriage in the forward direction in the reading operation as a forward abnormality; or
when circuitry moves the carriage in the return direction in the reading operation as a return abnormality;
perform the image reading when the circuitry determines that the carriage has the forward abnormality; and
not perform the image reading when the circuitry determines that the carriage has the return abnormality.

4. The image reading device according to claim 2,
wherein the circuitry is further configured to:
determine whether the carriage has the abnormality; and
perform the second reciprocal scanning operation,
when the circuitry moves the carriage to the reference white plate.

5. The image reading device according to claim 1,
wherein the circuitry is further configured to stores, in a memory, a history of abnormalities of the carriage.

6. The image reading device according to claim 1, further comprising an operation panel screen,
wherein the circuitry is further configured to:
control the operation panel screen to display a screen pattern of the abnormality of the carriage,
when the circuitry determines that the carriage has the abnormality.

7. The image reading device according to claim 1, wherein
the image reading device includes at least one of:
a copier printer;
a scanner transmitter; or
a facsimile transmitter.

8. An image forming apparatus comprising:
the image reading device according to claim 1; and
an image former to form an image read by the image reading device on a medium.
